(19) United States
(12) Patent Application Publication
(10) Pub. No.: US 2026/0004116 A1
(43) Pub. Date: Jan. 1, 2026

(54) QUANTIZED NEURAL NETWORK MODEL NORMALIZATION METHOD AND SYSTEM THEREOF

(71) Applicant: Samsung Electronics Co., Ltd., Suwon-si (KR)

(72) Inventors: Chang Gwun LEE, Suwon-si (KR); Su Min SONG, Suwon-si (KR); Hyoung Jun JEON, Suwon-si (KR); Sang Hyuck HA, Suwon-si (KR)

(21) Appl. No.: 19/073,442

(22) Filed: Mar. 7, 2025

(30) Foreign Application Priority Data
Jul. 1, 2024 (KR) 10-2024-0086341
Oct. 4, 2024 (KR) 10-2024-0134685

(51) Int. Cl. G06N 3/0495; G06N 3/045

(52) U.S. Cl. CPC G06N 3/0495; G06N 3/045

(57) ABSTRACT

A neural network model normalization method may include selecting a first normalization layer included in a first model obtained by quantizing a second model; adjusting the first normalization layer; and providing the first model including the adjusted first normalization layer for deployment on an external device. The adjusting of the first normalization layer includes: adjusting a first input tensor of the first normalization layer to be normalized based on a first error between a second input tensor of a second normalization layer included in the second model and a third input tensor of a third normalization layer included in a third model obtained by dequantizing the first model; and adjusting an first output tensor of the first normalization layer to be corrected based on a second error between a second output tensor of the second normalization layer and a third output tensor of the third normalization layer.

### CROSS-REFERENCE TO RELATED APPLICATION

This application claims priority from Korean Patent Application No. 10-2024-0086341 filed on Jul. 1, 2024, and Korean Patent Application No. 10-2024-0134685 filed on Oct. 4, 2024, in the Korean Intellectual Property Office, and all the benefits accruing therefrom under 35 U.S.C. 119, the contents of which in its entirety are herein incorporated by reference.

### TECHNICAL FIELD

The present invention relates to a normalization method of a neural network model and system thereof, and more particularly, to a normalization method of a neural network model for compensating for errors due to quantization of the neural network model.

### BACKGROUND

While a large number of large-scale language models (LLM) have been developed, and various tasks may be performed using these models, it may be desirable to not only drive the large-scale language models on a server, but also to drive models on a user terminal such as a smartphone. In general, in order to perform a task using a neural network model on a user terminal, the neural network model is quantized so that a model trained with 32-bit floating-point data on the server may use data with smaller or fewer bits, such as 16-bit floating-point, 16-bit integer, and 8-bit integer. In this process, the accuracy of the neural network model may decrease due to bit loss. In particular, in the case of a large-scale language model (LLM), because the overall size of the model may be large and the number of internal layers may be large, the accuracy of the neural network model may significantly decrease in accordance with the accumulation of quantization errors due to quantization.

### SUMMARY

Aspects of the present invention provide a method for adjusting a normalization layer to perform normalization of an input tensor by reflecting an error in the input tensor due to quantization in the normalization layer of a quantized neural network model.

Aspects of the present invention also provide a method for adjusting a normalization layer to perform correction of an output tensor by reflecting an error in the output tensor due to quantization in the normalization layer of a quantized neural network model.

Further, aspects of the present invention also provide a method for deploying a quantized neural network model including the normalization layer adjusted through the above-mentioned embodiments to a user terminal.

A neural network model normalization method according to some embodiments may include executing, by at least one processor of a computing device, computer program instructions stored in a non-transitory computer readable medium to perform operations comprising: selecting a first normalization layer included in a first neural network model, where the first neural network model is a quantized neural network model obtained by quantizing a second neural network model; adjusting the first normalization layer; and providing the first neural network model, including the first normalization layer that was adjusted, for deployment on an external device that is different than the computing device. The adjusting of the first normalization layer may include adjusting a first input tensor of the first normalization layer to be normalized based on a first error between a second input tensor of a second normalization layer included in the second neural network model, and a third input tensor of a third normalization layer included in a third neural network model obtained by dequantizing the first neural network model; and adjusting an first output tensor of the first normalization layer to be corrected based on a second error between a second output tensor of the second normalization layer and a third output tensor of the third normalization layer, where the second normalization layer and the third normalization layer correspond to the first normalization layer.

A neural network model normalization system according to some embodiments may include a processor; and a memory configured to store computer program instructions therein, which, when executed by the processor, cause the processor to perform operations comprising: selecting a first normalization layer included in a first neural network model, where the first neural network model is a quantized neural network model obtained by quantizing a second neural network model; adjusting the first normalization layer; and providing the first neural network model, including the first normalization layer that was adjusted, for deployment on an external device. The adjusting the first normalization layer may include adjusting a first input tensor of the first normalization layer to be normalized based on a first error between a second input tensor of a second normalization layer included in the second neural network model, and a third input tensor of a third normalization layer included in a third neural network model obtained by dequantizing the first neural network model; and adjusting an first output tensor of the first normalization layer to be corrected based on a second error between a second output tensor of the second normalization layer and a third output tensor of the third normalization layer, where the second normalization layer and the third normalization layer correspond to the first normalization layer.

A non-transitory computer-readable medium according to some embodiments may store computer program instructions, which, when executed by a processor, cause the processor to perform operations of: selecting a first normalization layer included in a first neural network model, where the first neural network model is a quantized neural network model obtained by quantizing a second neural network model; adjusting the first normalization layer; and providing the first neural network model, including the first normalization layer that was adjusted, for deployment on an external device. The adjusting the first normalization layer may include adjusting a first input tensor of the first normalization layer to be normalized based on a first error between a second input tensor of a second normalization layer included in the second neural network model, and a third input tensor of a third normalization layer included in a third neural network model obtained by dequantizing the first neural network model; and adjusting an first output tensor of the first normalization layer to be corrected based on a second error between a second output tensor of the second normalization layer and a third output tensor of the third normalization layer, where the second normalization layer and the third normalization layer correspond to the first normalization layer.

### BRIEF DESCRIPTION OF THE DRAWINGS

The above and other aspects and features of the present invention will become more apparent by describing in detail exemplary embodiments thereof referring to the attached drawings, in which:

FIG. 1 is a block diagram showing an example of a configuration of an overall system according to an embodiment of the present disclosure;

FIG. 2 shows an input tensor and an error for the input tensor according to an embodiment of the present disclosure;

FIG. 3 shows an output tensor and an error for the output tensor according to an embodiment of the present disclosure;

FIG. 4 is a flowchart exemplarily showing a method for normalizing a neural network model according to an embodiment of the present disclosure;

FIG. 5 is a flowchart specifically showing step S210 of adjusting (for example, adjusting an input tensor) to be normalized on the basis of a first error of FIG. 4;

FIG. 6 is a flowchart specifically showing step S220 of adjusting (for example, adjusting an output tensor) to be corrected on the basis of a second error of FIG. 4;

FIG. 7 shows an example of a configuration of a quantized neural network model according to an embodiment of the present disclosure; and

FIG. 8 is a block diagram showing a hardware configuration of a computing device including the neural network model according to an embodiment of the present disclosure.

### DETAILED DESCRIPTION OF EMBODIMENTS

Hereinafter, embodiments of the present disclosure will be described in detail with reference to the attached drawings. Advantages and features of the present disclosure, and methods of achieving the advantages and features will become apparent with reference to embodiments described later in detail together with the accompanying drawings. However, embodiments of the present disclosure are not limited to the embodiments as disclosed below, but may be implemented in various different forms. Thus, these embodiments are set forth only to make the present disclosure complete, and to completely inform the scope of the present disclosure to those of ordinary skill in the technical field to which the present disclosure belongs, and the present disclosure is only defined by the scope of the claims.

The same reference numbers in different drawings represent the same or similar elements, and as such perform similar functionality. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure the inventive concepts of the present disclosure. Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. The terminology used herein is directed to describing particular embodiments only and is not intended to be limiting of the present disclosure. As used herein, the singular constitutes “a” and “an” are intended to include the plural constitutes as well, unless the context clearly indicates otherwise.

Additionally, in describing the components of the present disclosure, terms such as first, second, A, B, a, and b may be used. These terms are only used to distinguish one component from another component, and the nature, sequence, order, or number of the component are not limited by the term. It should be understood that when a component is described as being “connected,” “coupled,” or “combined” to another component, the component may be directly connected, coupled, or combined to another component, or still another component may be “interposed” therebetween, and thus the component may be connected, coupled, or combined to another component via the still another component.

It will be further understood that the terms “comprise”, “comprising”, “include”, and “including” as used herein specify the presence of the stated features, steps, operations, elements, and/or components, but do not preclude the presence or addition of one or more other features, steps, operations, elements, components, and/or portions thereof. The term “and/or” includes any and all combinations of one or more of the associated listed items. The term “previous” or “before” may be used herein to refer to elements or calculations or models that precede the current one in a series, sequence, or timeline. The term “correspond” may be used herein to indicate that a particular element or calculation or layer of one model is functionally similar or equivalent to an element or calculation or layer of another model.

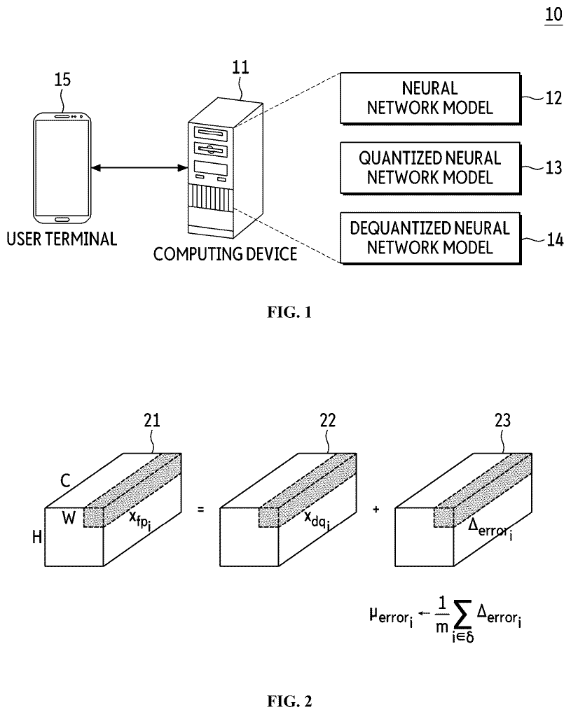

FIG. 1 is a block diagram showing an example of a configuration of an entire or overall system according to an embodiment of the present disclosure. Referring to FIG. 1, the overall system 10 may include a computing device 11 and a user terminal 15. The computing device 11 according to an embodiment of the present disclosure may be configured to implement or otherwise include neural network models 12, 13, and 14.

For reference, the neural network model of the present disclosure may refer to a non-transitory neural network model that can learn a relatively large amount or volume of text (e.g., text of or associated with various domains) and may have a universal understanding ability with respect to multiple languages (or natural language/text). The neural network model of the present disclosure may be considered as a large-scale model with query and response capabilities on the basis of a text interface, and may also be considered as a model that may “generate” responses to queries, and therefore may be named as a “largescale language model (LLM)”, a “generative AI model”, a “query-answer model”, a “conversational model”, or the like. For example, the neural network model may be implemented as a transformer based on attention methods. The neural network model can be constructed as multiple non-transitory models that can execute in parallel.

More specifically, the computing device 11 may select any normalization layer included in the quantized neural network model 13. The quantized neural network model 13 may be obtained by quantizing the neural network model 12. Further, the computing device 11 may adjust the normalization layer included in the quantized neural network model 13 to compensate for a quantization error that occurs when the neural network model 12 is quantized to become or to generate the quantized neural network model 13. The adjustment of the normalization layer may be roughly or conceptually divided into adjustment of the input tensor and adjustment of the output tensor. In the following descriptions, the input tensor and output tensor of the normalization layer of the quantized neural network model 13 will be represented as a first input tensor and a first output tensor, respectively.

First, the computing device 11 may adjust the normalization layer so that the first input tensor is normalized on the basis of an error between an input tensor (hereinafter, a second input tensor) of the normalization layer included in the neural network model 12 before quantization (also referred to as the pre-quantized neural network model 12), and an input tensor (hereinafter, a third input tensor) of the normalization layer included in the network model 14 (also referred to as the de-quantized neural network model 14) acquired by dequantizing the quantized neural network model 13.

Hereinafter, an embodiment related to the normalization of the first input tensor will be specifically considered referring to FIG. 2.

FIG. 2 shows an input tensor and an error for the input tensor according to an embodiment of the present disclosure. Referring to FIG. 2, reference numeral 21 corresponds to an input feature map that is input to the normalization layer of the neural network model 12 before quantization, reference numeral 22 corresponds to an input feature map that is input to the normalization layer of the dequantized neural network model 14, and reference numeral 23 corresponds to an error between the two feature maps. That is, a portion indicated by gray or shading in the input feature map 21 corresponds to an input tensor (i.e., a second input tensor) x_{fp_i} that is input to the normalization layer of the neural network model 12 before quantization, a portion indicated by gray or shading in the input feature map 22 corresponds to an input tensor (i.e., a third input tensor) x_{dq_i} that is input to the normalization layer of the dequantized neural network model 14, and a portion indicated by gray or shading in the input feature map 24 may correspond to an Δerrorᵢ between the second input tensor and the third input tensor (i.e., an quantization error). Such an error may be calculated in real time in accordance with the input of the sample data set, and may be accumulated, and the result thereof may be stored in a memory or a storage (e.g., DRAM) of the computing device 11.

The computing device 11 may compensate for the average of the input tensor of the normalization layer included in the quantized neural network model 13 from the quantization error calculated in advance. For example, the average of the second input tensor may be expressed using the third input tensor and the quantization error as shown in the following Formula 1.

$$E ( {x}_{dq\_i} + {Δerror}_{i} ) = E ( {x}_{dq\_i} ) + E ( {Δerror}_{i} ) \qquad [ Formula 1 )$$

Here, E(Δerrorᵢ) corresponds to an average of the quantization error, and in the normalization process of the first input tensor, the average value of the quantization error described above is added to the average of the first input tensor, and the compensation average value for the first input tensor may be calculated. That is, the normalization of the first input tensor may be performed in accordance with following Formula 2.

$${\hat{x}}_{i} = \frac{{μ}_{i} + {μ}_{error}}{\sqrt{σ {}_{i}^{2} + ϵ}} \qquad [ Formula 2 ]$$

Here, \hat{x}ᵢ corresponds to a normalized first input tensor, μᵢ is an average of the first input tensor, μₑᵣᵣₒᵣ is the above-mentioned quantization error,

$$σ {}_{i}^{2}$$

is the variance of the first input tensor, and ϵ is a constant for adjusting the quantization error so that the denominator does not become 0. The quantization error for the first input tensor may be compensated through the above embodiment.

Returning to FIG. 1, the input tensor normalized in this way may be linearly corrected, using the parameters of the normalization layer. For example, if the two parameters of the normalization layer are defined as β and γ, respectively, the normalized input tensor \hat{x}ᵢ may be corrected as γ\hat{x}ᵢ+β, and the γ\hat{x}ᵢ+β value may correspond to the first output tensor yᵢ.

In order to compensate for the quantization error even for the first output tensor, the computing device 11 may adjust the normalization layer so that the first output tensor is corrected on the basis of the error between an output tensor (hereinafter, a second output tensor) of the normalization layer included in the neural network model 12 before quantization and an output tensor (hereinafter, a third output tensor) of the normalization layer included in the dequantized neural network model 14.

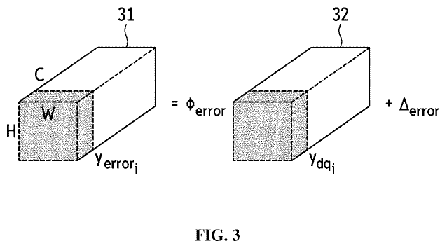

Hereinafter, an embodiment related to the correction of the first output tensor will be specifically considered referring to FIG. 3.

FIG. 3 shows an output tensor and an error for the output tensor according to an embodiment of the present disclosure. Referring to FIG. 3, reference numeral 31 corresponds to an output feature map including an error y_{error_i} between the output tensor (i.e., the second output tensor) output from the normalization layer of the neural network model 12 before quantization and the output tensor (i.e., the third output tensor) output from the normalization layer of the dequantized neural network model 14, and reference numeral 32 corresponds to an output feature map that is output from the normalization layer of the dequantized neural network model 14. A portion indicated by gray or shading in the output feature map 32 corresponds to the third output tensor y_{dq_i}. Φₑᵣᵣₒᵣ and Δₑᵣᵣₒᵣ represent parameters of linear regression. That is, in FIG. 3, the error y_{error_i} indicates an error value estimated by applying the linear regression to the third output tensor y_{dq_i}.

The computing device 11 may calculate a mean square error (MSE) between an actual error between the second output tensor and the third output tensor, and an estimated error between the second output tensor and the third output tensor as shown in following Formula 3.

$${\sum }_{i = 1}^{n} {( {y}_{{error}_{i}} - ( scale \cdot {y}_{{dq}_{i}} + bias ) )}^{2} \qquad [ Formula 3 ]$$

In Formula 3, y_{error_i} is the actual error between the second output tensor and the third output tensor, and scale and bias correspond to Φₑᵣᵣₒᵣ and Δₑᵣᵣₒᵣ, respectively, as shown in FIG. 3. In order to reduce or minimize the MSE calculated in this way, a gradient descent method or a linear regression may be used repeatedly. Accordingly, the scale value (i.e., Φₑᵣᵣₒᵣ value) and bias value (i.e., Δₑᵣᵣₒᵣ value) that reduce or minimize the error between the actual error and the estimated error may be determined. In other words, the computing device 11 may determine the parameters that reduce or minimize the error between the actual error and the estimated error, among the parameters of the linear regression used to determine the estimated error.

After the parameters scale and bias that reduce or minimize the MSE calculated through Formula 3 are determined, this may be reflected in \hat{x}ᵢ that is the normalized first input tensor. That is, the computing device 11 may use the (scale*\hat{x}ᵢ+bias) value instead of \hat{x}ᵢ in the process of acquiring the first output tensor yᵢ as γ\hat{x}ᵢ+β. The finally corrected first output tensor may be calculated as yᵢ′=γ*scale*\hat{x}ᵢ+γ*bias+β. That is to say, the corrected first output tensor is calculated as yᵢ′=γ′\hat{x}ᵢ+β′, and may correspond to γ′=γ*scale, β′=γ*bias+β. The quantization error for the first output tensor may be compensated for through the above embodiment.

The computing device 11 may adjust up to all of the normalization layers of the quantized neural network model 13 so that the compensation for the quantization error for the first input tensor and the compensation for the quantization error for the first output tensor are performed. Since the layers themselves are adjusted, the quantization error may be compensated for in any or all normalization processes performed later in the quantized neural network model 13 without additional computations.

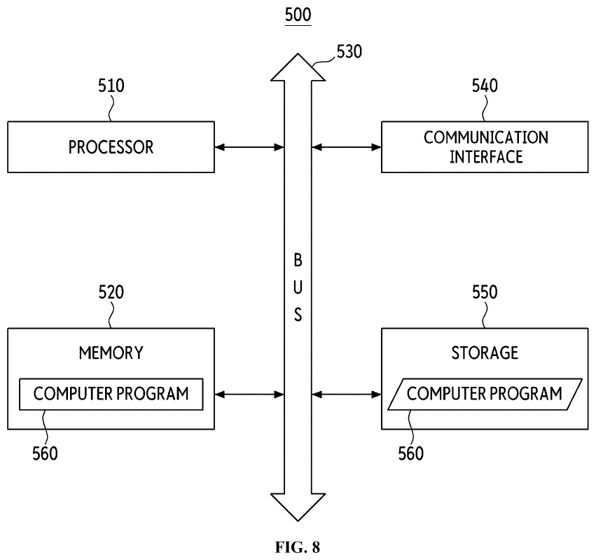

Returning to FIG. 1 again, the computing device 11 may deploy the quantized neural network model 13, in which normalization layers are adjusted according to the above-mentioned embodiment, to the user terminal 15. Here, the degree of quantization may vary on the basis of the specifications of the user terminal 15. For example, the user terminal 15 may include or may otherwise have access to comparatively fewer computing resources (e.g., with respect to processing ability, processing speed, and/or memory) than the computing device 11. Meanwhile, the computing device 11 may be configured using one or more physical servers included in a server farm on the basis of cloud technology such as a virtual machine. A specific configuration and the computing device 11 according to an embodiment of the present disclosure will be described below referring to FIG. 8.

The user terminal 15 is a terminal used by a user to perform a specific task, by utilizing the quantized neural network model 13 deployed from the computing device 11. For example, the user terminal 15 may include a smartphone, a tablet PC, a laptop, etc., but the present disclosure is not limited thereto, and the user terminal 15 may include any or all types of computing devices equipped with computing resources and/or communication resources, which may differ from those of the computing device 11.

The constituent elements shown in FIG. 1 may communicate through a network. For example, the network may be implemented as any or all types of wired/wireless networks such as a local area network (LAN), a wide area network (WIN), a mobile radio communication network, and a wireless broadband internet (Wibro).

Embodiments related to the context window expansion of the quantized neural network model 13 will be considered below.

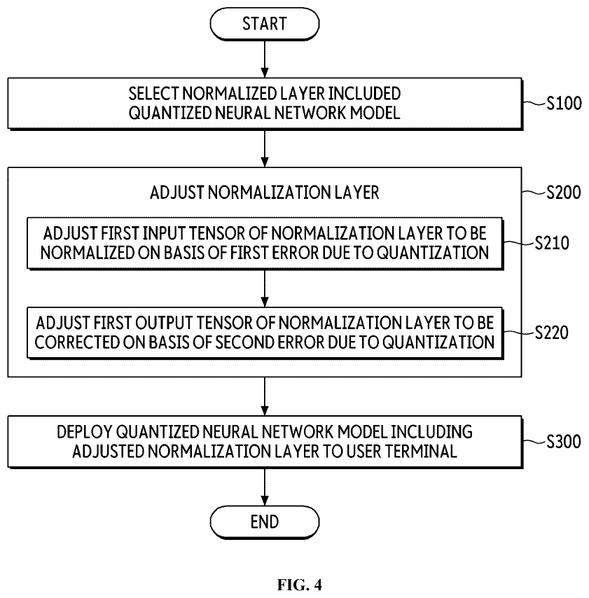

FIG. 4 is a flowchart showing an exemplary method for normalizing a neural network model according to an embodiment of the present disclosure. For reference, FIGS. 4 and 5 to 6 to be described below show steps/operations performed by the computing device 11 of FIG. 1 or the computing device 500 of FIG. 8. Therefore, in the following descriptions, when the subject of a particular step/operation is omitted, it may be understood that the corresponding step/operation is performed by the computing device 11 of FIG. 1 or the computing device 500 of FIG. 8.

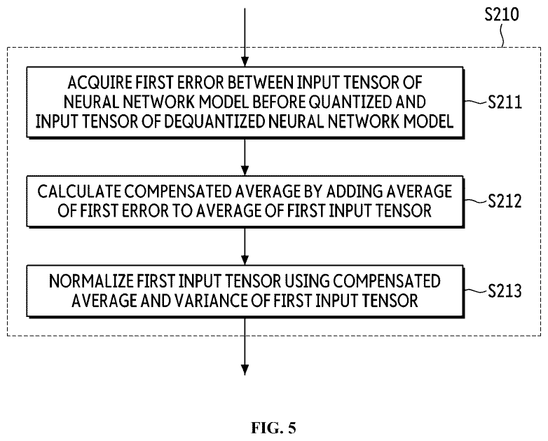

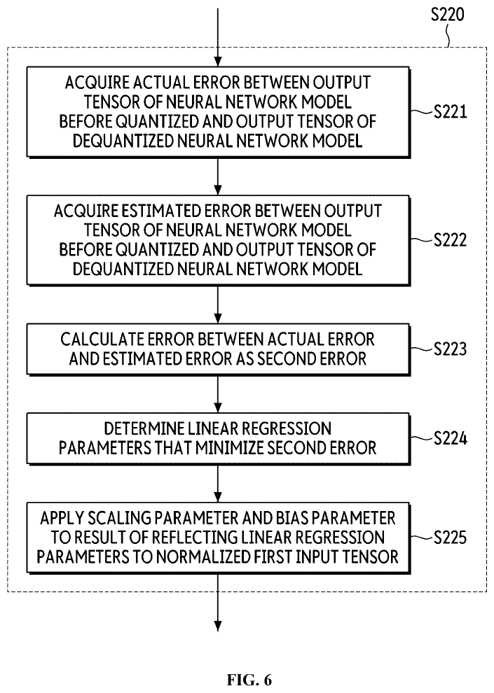

In step S100, a first normalization layer included in a first model that is a quantized neural network model (e.g., reference number 13 of FIG. 1) may be selected. Here, the first normalization layer may be a layer included in an attention block of a transformer model. In step S200, the first normalization layer may be adjusted. Specifically, in step S210, a first input tensor of the first normalization layer may be adjusted to be normalized on the basis of a first error between the second input tensor of a second normalization layer included in a second model that is a neural network model e.g., (reference number 12 of FIG. 1) before the first model is quantized, and a third input tensor of the third normalization layer included in a third model that is a neural network model e.g., (e.g., reference number 14 of FIG. 1) acquired by dequantizing the first model. Here, the second normalization layer and the third normalization layer may correspond to the first normalization layer. As noted above, layers that correspond may refer to functionally similar or equivalent layers of the respective neural network models. Step S210 will be described below referring to FIG. 5.

FIG. 5 is a flowchart specifically showing step S210 of adjusting the first input tensor to be normalized on the basis of the first error of FIG. 4. Referring to FIG. 5, in step S211, the first error may be acquired from a storage or a memory (e.g., DRAM) included in the computing device (11 of FIG. 1). At this time, the first error is a value obtained by accumulating the error between the second input tensor of the second normalization layer when an arbitrary sample data set is input to the second model before quantization and the third input tensor of the third normalization layer when the arbitrary sample data set is input to the dequantized third model, and a newly accumulated value may be stored in the storage or the memory at that time.

In step S212, the compensated average of the first input tensor may be calculated, by adding the average of the first error to the average of the first input tensor. Since the first error calls the already stored value, almost no additional computation time and/or no additional computation resources may be consumed in the process of calculating the compensated average of the first input tensor. Thereafter, in step S213, the first input tensor may be normalized, using the compensated average and the variance of the first input tensor. For example, normalization of the first input tensor may be performed by dividing the value acquired by subtracting the compensated average of the first input tensor from the first input tensor by the variance of the first input tensor. That is, by using the already stored value of the first error, the first input tensor may be normalized while substantially avoiding additional computation burden.

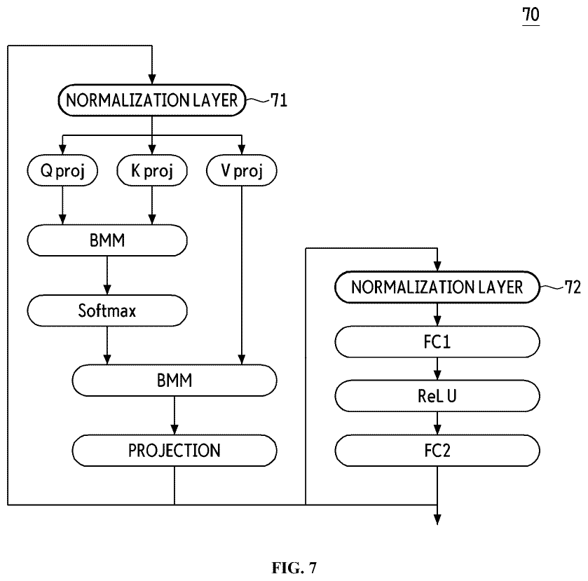

Returning again to FIG. 4, in step S220, the first output tensor of the first normalization layer may be adjusted to be corrected on the basis of the second error between the second output tensor of the second normalization layer and the third output tensor of the third normalization layer. Hereinafter, step S220 will be described referring to FIG. 6.

FIG. 6 is a flowchart specifically showing step S220 of adjusting the first output tensor to be corrected on the basis of the second error of FIG. 4. Referring to FIG. 6, the actual error between the second output tensor and the third output tensor may be acquired in step S221. For example, as described referring to FIG. 5, the actual error between the second output tensor of the second normalization layer included in the second model before quantization and the third output tensor of the third normalization layer included in the dequantized third model may be calculated for the sample data set, and the calculated actual error may be accumulated and stored in a memory or a storage.

An estimated error between the second output tensor and the third output tensor may be calculated in step S222. As described referring to FIG. 3, the estimated error between the second output tensor and the third output tensor may be calculated by applying a linear regression to the third output tensor. The error between the actual error and the estimated error may be calculated as the second error in step S223. Specifically, as described referring to FIG. 3, the second error may correspond to the mean square error (MSE) between the actual error and the estimated error.

Parameters of the linear regression that reduce or minimize the second error may be determined in step S224. In step S225, the parameters of the linear regression may be reflected on the normalized first input tensor, and a scaling parameter and a bias parameter may be applied to the reflected result. For example, the scaling parameter may be multiplied by the reflected result, and the bias parameter may be added to the product of the reflected result and the scaling parameter. Here, the scaling parameter and the bias parameter may be parameters of the first normalized layer.

Returning again to FIG. 4, in step S300, the first model including the first normalization layer adjusted according to the above-mentioned embodiments may be deployed to the user terminal 15. At this time, the first model may be quantized on the basis of the specifications of the user terminal 15, which may include or may otherwise have access to comparatively fewer computing resources than the computing device 11. That is, the number of bits of the quantized neural network model 13 of FIG. 1 is quantized to become smaller than the number of bits of the neural network model 12, but how small the number of bits is (i.e., how much it is quantized) may be determined in accordance with the specifications of the user terminal 15.

FIG. 7 exemplarily shows a configuration of a quantized neural network model 70 according to an embodiment of the present disclosure. For example, the quantized neural network model 70 of FIG. 7 may correspond to the quantized neural network model 13 of FIG. 1. The quantized neural network model 70 may include fewer layers, reduced dimensionality (e.g., number of parameters), fewer nodes (e.g., by setting parameters to zero and/or otherwise excluding nodes when performing computations), and/or otherwise reduced complexity (e.g., using data of fewer/smaller bit sizes) in comparison to the pre-quantized neural network model 12, such that the model 70 may execute with comparatively decreased memory and/or computational requirements, while improving or maintaining accuracy based on quantization error compensation as described herein. The quantized neural network model 70 of FIG. 7 shows a case where it is implemented as a transformer model, and the normalization layers 71 and 72 are shown to be included in the attention block. Specifically, the normalization layer 71 may be connected to query projection (Q proj), key projection (K proj), and value projection (V proj) layers, and the output tensor of the normalization layer 71 may pass through a batch map multiplication (BMM) layer and a softmax layer (Softmax) via the query projection, key projection, and value projection. Further, the output tensor of the normalization layer 72 may pass through the full connection layers FC1 and FC2, and a ReLU layer. The normalization layer 71 and the normalization layer 72 may be adjusted according to the above-mentioned embodiments of the present disclosure, and the error due to quantization of the quantized neural network model 70 may be compensated.

FIG. 8 is a block diagram showing a hardware configuration of a computing device including a neural network model according to an embodiment of the present disclosure.

Referring to FIG. 8, the computing device 500 includes one or more processors 510, a bus 530, a communication interface 540, and a memory 520 for loading a computer program executed by the processor 510, and a storage 550 for storing a computer program 560. However, FIG. 8 shows only constituent elements related to the embodiment of the present disclosure. Therefore, a person skilled in the art to which the present disclosure belongs will understand that other general-purpose constituent elements may be further included in addition to the constituent elements shown in FIG. 8. That is, the computing device 500 may further include various constituent elements in addition to the constituent elements shown in FIG. 8. In some cases, the computing device 500 may be configured in a form in which some of the constituent elements shown in FIG. 8 are omitted. Each constituent element of the computing device 500 will be described below.

The processor 510 may control the overall operation of each configuration of the computing device 500. The processor 510 may be configured to include at least one of a central processing unit (CPU), a micro processor unit (MPU), a micro controller unit (MCU), a graphic processing unit (GPU) or any form of processor known in the art of the present disclosure. Furthermore, the processor 510 may execute computations for at least one application or program for performing operations/methods according to the embodiments of the present disclosure. The computing device 500 may include one or more processors.

The memory 520 may store various types of data, instructions and/or information. The memory 520 may load the computer program 560 from the storage 550 to perform operations/methods according to the embodiments of the present disclosure. The memory 520 may be implemented as a volatile memory such as a RAM, but the present disclosure is not limited thereto.

The bus 530 may provide communication functions between the constituent elements of the computing device 500. The bus 530 may be implemented as various forms of buses, such as an address bus, a data bus and a control bus.

The communication interface 540 may support wired or wireless Internet communication of the computing device 500. Furthermore, the communication interface 540 may support various communication methods other than Internet communication. For this purpose, the communication interface 540 may be configured to include a communication module well known in the technical field of the present disclosure.

The storage 550 may non-temporarily store one or more computer programs 560. The storage 550 may be configured to include a non-volatile memory such as a read only memory (ROM), an erasable programmable ROM (EPROM), an electrically erasable programmable ROM (EEPROM) and a flash memory, a hard disk, a detachable disk, or any form of non-transitory computer-readable recording medium well known in the technical field to which the present disclosure belongs.

The computer program 560 may include one or more instructions that cause the processor 510 to perform the operations/methods according to various embodiments of the present disclosure, when loaded into the memory 520. That is, the processor 510 may perform the operations/methods according to various embodiments of the present disclosure by executing the one or more loaded instructions.

For example, the computer program 560 may include instructions for performing operations of selecting a first normalization layer included in a first model that is a quantized neural network model, and adjusting the first normalization layer. The adjusting the first normalization layer may include adjusting the first input tensor of the first normalization layer to be normalized on the basis of the first error between the second input tensor of the second normalization layer included in the second model, which is the neural network model before the first model is quantized, and the third input tensor of the third normalization layer included in the third model, which is a neural network model obtained by dequantizing of the first model, and adjusting the first output tensor of the first normalization layer to be corrected on the basis of a second error between the second output tensor of the second normalization layer and the third output tensor of the third normalization layer.

According to the embodiment of the present disclosure, when a quantized generative artificial intelligence model or a large-scale language model operates on a user terminal (which may include comparatively fewer computing resources), the accuracy of the (comparatively less complex) quantized neural network model may be improved by maximally compensating for the quantization error in the normalization layer. In particular, when simply adjusting the normalization layer in the hardware that performs the computation of the normalization layer, because the quantization error can be compensated for when operating on the user terminal later even without additional computation, it can be advantageous in terms of delay time, and the power consumption of the user terminal can be reduced when the quantized neural network model operates.

Various embodiments of the present disclosure and the effects according to those embodiments have been mentioned above with reference to FIGS. 1 to 8. The effects according to the technical ideas and inventive concepts of the present disclosure are not limited to the effects as mentioned above, and other effects not mentioned may be clearly understood by those skilled in the art from the above descriptions.

All the components that constitute the embodiment of the present disclosure are described as being combined with each other or operating in combination with each other. However, the present disclosure is not necessarily limited to this embodiment. In other words, within the scope of the present disclosure, all of the components may operate in a selective combination manner of at least two thereof with each other.

Although the operations in the flowcharts and diagrams are shown as being executed in a specific order in the drawings, it should not be understood that the operations should be performed in the specific order as shown or in a sequential order or that all illustrated operations should be performed to obtain the desired result. That is, the operations described herein are not limited to the order or sequence of performance illustrated in the flowcharts or other diagrams, and may be performed in other orders or sequences not explicitly illustrated to achieve the desired output.

Although embodiments of the present disclosure have been described with reference to the accompanying drawings, embodiments of the present disclosure are not limited to the above embodiments, but may be implemented in various different forms. A person skilled in the art may appreciate that the present disclosure may be practiced in other concrete forms without changing the scope of the present disclosure. Therefore, it should be appreciated that the embodiments as described above is not restrictive but illustrative in all respects.

What is claimed is:

1. A neural network model normalization method performed by a computing device, comprising:
executing, by at least one processor of the computing device, computer program instructions stored in a non-transitory computer readable medium to perform operations comprising:
selecting a first normalization layer included in a first neural network model, wherein the first neural network model is a quantized neural network model obtained by quantizing a second neural network model;
adjusting the first normalization layer; and
providing the first neural network model, including the first normalization layer that was adjusted, for deployment on an external device that is different than the computing device,
wherein the adjusting of the first normalization layer comprises:
adjusting a first input tensor of the first normalization layer to be normalized based on a first error between a second input tensor of a second normalization layer included in the second neural network model, and a third input tensor of a third normalization layer included in a third neural network model obtained by dequantizing the first neural network model;
adjusting a first output tensor of the first normalization layer to be corrected based on a second error between a second output tensor of the second normalization layer and a third output tensor of the third normalization layer,
wherein the second normalization layer and the third normalization layer correspond to the first normalization layer.

2. The neural network model normalization method of claim 1, wherein the adjusting the first input tensor to be normalized based on the first error comprises:
acquiring the first error;
calculating a compensated average of the first input tensor by adding an average of the first error to an average of the first input tensor; and
normalizing the first input tensor, using the compensated average and a variance of the first input tensor.

3. The neural network model normalization method of claim 1, wherein the first error is obtained by accumulating the second input tensor of the second normalization layer when a sample data set is input to the second neural network model, and the third input tensor of the third normalization layer when the sample data set is input to the third neural network model.

4. The neural network model normalization method of claim 1, wherein the adjusting the first output tensor to be corrected based on the second error comprises:
acquiring an actual error between the second output tensor and the third output tensor;
acquiring an estimated error between the second output tensor and the third output tensor; and
calculating an error between the actual error and the estimated error as the second error.

5. The neural network model normalization method of claim 4, wherein the estimated error is obtained by applying a linear regression to the third output tensor, and
wherein the adjusting the first output tensor to be corrected based on the second error comprises:
determining parameters of the linear regression that reduce or minimize the second error; and
applying a scaling parameter and a bias parameter to a result of reflecting the parameters of the linear regression on the first input tensor that was normalized.

6. The neural network model normalization method of claim 5, wherein the second error is a mean square error (MSE) between the actual error and the estimated error, and the scaling parameter and the bias parameter are parameters of the first normalization layer.

7. The neural network model normalization method of claim 1, wherein the first neural network model is a transformer model including an attention block, and the first normalization layer is included in the attention block.

8. The neural network model normalization method of claim 1, wherein the operations further comprise:
deploying the first neural network model including the first normalization layer that was adjusted to the external device, wherein the external device is a user terminal having fewer computing resources than the computing device,
wherein the first neural network model is quantized based on one or more specifications of the user terminal.

9. A neural network model normalization system comprising:
a processor; and
a memory configured to store computer program instructions therein, which, when executed by the processor, cause the processor to perform operations comprising:
selecting a first normalization layer included in a first neural network model, wherein the first neural network model is a quantized neural network model obtained by quantizing a second neural network model;
adjusting the first normalization layer; and
providing the first neural network model, including the first normalization layer that was adjusted, for deployment on an external device,
wherein the adjusting the first normalization layer comprises:
adjusting a first input tensor of the first normalization layer to be normalized based on a first error between a second input tensor of a second normalization layer included in the second neural network model, and a third input tensor of a third normalization layer included in a third neural network model obtained by dequantizing the first neural network model; and
adjusting a first output tensor of the first normalization layer to be corrected based on a second error between a second output tensor of the second normalization layer and a third output tensor of the third normalization layer,
wherein the second normalization layer and the third normalization layer correspond to the first normalization layer.

10. The neural network model normalization system of claim 9, wherein the adjusting the first input tensor to be normalized based on the first error comprises:
acquiring the first error;
calculating a compensated average of the first input tensor by adding an average of the first error to an average of the first input tensor; and
normalizing the first input tensor, using the compensated average and a variance of the first input tensor.

11. The neural network model normalization system of claim 9, wherein the first error is obtained by accumulating the second input tensor of the second normalization layer when a sample data set is input to the second neural network model, and the third input tensor of the third normalization layer when the sample data set is input to the third neural network model.

12. The neural network model normalization system of claim 9, wherein the adjusting the first output tensor to be corrected based on the second error comprises:
acquiring an actual error between the second output tensor and the third output tensor;
acquiring an estimated error between the second output tensor and the third output tensor; and
calculating an error between the actual error and the estimated error as the second error.

13. The neural network model normalization system of claim 12, wherein the estimated error is obtained by applying a linear regression to the third output tensor, and
wherein the adjusting the first output tensor to be corrected based on the second error comprises:
determining parameters of the linear regression that reduce or minimize the second error; and
applying a scaling parameter and a bias parameter to a result of reflecting the parameters of the linear regression on the first input tensor that was normalized.

14. The neural network model normalization system of claim 13, wherein the second error is a mean square error (MSE) between the actual error and the estimated error, and the scaling parameter and the bias parameter are parameters of the first normalization layer.

15. A non-transitory computer-readable medium having computer program instructions stored therein, which, when executed by a processor, cause the processor performs operations comprising:
selecting a first normalization layer included in a first neural network model, wherein the first neural network model is a quantized neural network model obtained by quantizing a second neural network model;
adjusting the first normalization layer; and
providing the first neural network model, including the first normalization layer that was adjusted, for deployment on an external device,
wherein the adjusting the first normalization layer comprises:
adjusting a first input tensor of the first normalization layer to be normalized based on a first error between a second input tensor of a second normalization layer included in the second neural network model, and a third input tensor of a third normalization layer included in a third neural network model obtained by dequantizing the first neural network model; and
adjusting a first output tensor of the first normalization layer to be corrected based on a second error between a second output tensor of the second normalization layer and a third output tensor of the third normalization layer,
wherein the second normalization layer and the third normalization layer correspond to the first normalization layer.

16. The non-transitory computer-readable medium of claim 15, wherein the adjusting the first input tensor to be normalized based on the first error comprises:
acquiring the first error;
calculating a compensated average of the first input tensor by adding an average of the first error to an average of the first input tensor; and
normalizing the first input tensor, using the compensated average and a variance of the first input tensor.

17. The non-transitory computer-readable medium of claim 15, wherein the first error is obtained by accumulating the second input tensor of the second normalization layer when a sample data set is input to the second neural network model, and the third input tensor of the third normalization layer when the sample data set is input to the third neural network model.

18. The non-transitory computer-readable medium of claim 15, wherein the adjusting the first output tensor to be corrected based on the second error comprises:
acquiring an actual error between the second output tensor and the third output tensor;
acquiring an estimated error between the second output tensor and the third output tensor; and
calculating an error between the actual error and the estimated error as the second error.

19. The non-transitory computer-readable medium of claim 18, wherein the estimated error is obtained by applying a linear regression to the third output tensor, and
the adjusting the first output tensor to be corrected based on the second error comprises:
determining parameters of the linear regression that reduce or minimize the second error; and
applying a scaling parameter and a bias parameter to a result of reflecting the parameters of the linear regression on the first input tensor that was normalized.

20. The non-transitory computer-readable medium of claim 19, wherein the second error is a mean square error (MSE) between the actual error and the estimated error, and the scaling parameter and the bias parameter are parameters of the first normalization layer.
